(19) United States
(12) Patent Application Publication
(10) Pub. No.: US 2002/0045429 A1
(43) Pub. Date: Apr. 18, 2002

(54) Communications systems

(76) Inventor: Jonas Persson, Lund (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/978,007

(22) Filed: Oct. 17, 2001

Related U.S. Application Data
(60) Provisional application No. 60/241,753, filed on Oct. 20, 2000.

(30) Foreign Application Priority Data
Oct. 18, 2000 (GB) 0025550-5

(51) Int. Cl. H04B 1/04

(52) U.S. Cl. 455/127; 455/126

(57) ABSTRACT

A method for controlling power output of a radio frequency transmitter, wherein information relating to statistical variations in the amplitude of the information signal that is to be transmitted is used to control a gain value of the radio frequency transmitter.

The present invention relates to communications systems, and in particular, to digital communications systems.

### BACKGROUND OF THE INVENTION

Typical current digital communication systems often use non-constant envelope modulation schemes, e.g. the new system EDGE (Enhanced Data rates for GSM Evolution) uses 3n/8-8PSK modulation. This means that some part of the information lies in the amplitude (envelope) of the transmitted signal and some part lies in the phase of the transmitted signal. In other words, this is a combination of Amplitude Modulation (AM) and Phase Modulation (PM).

The non-constant envelope makes feedback power control more difficult than for modulation types with constant envelope (e.g. GMSK modulation used in GSM). The reason is that the varying amplitude causes variations in power. Since the amplitude depends on the symbols that are sent, the measured power could vary between time-slots that are sent with the same nominal output power, i.e. the measured power could vary although the power control signal to the amplifier in the transmitter remains constant.

### SUMMARY OF THE PRESENT INVENTION

It is emphasised that the term “comprises” or “comprising” is used in this specification to specify the presence of stated features, integers, steps or components, but does not preclude the addition of one or more further features, integers, steps or components, or groups thereof.

According to one aspect of the present invention, there is provided a method for controlling power output of a radio frequency transmitter, wherein information relating to statistical variations in the amplitude of the information signal that is to be transmitted is used to control a gain value of the radio frequency transmitter.

Embodiments of the invention described below take the statistical amplitude variation of the non-constant envelope modulation into account, and compensate for it. The control signal to the amplifier will therefore not be influenced by the amplitude variations in the modulation signal. Of course, changes in transmitter gain because of e.g. temperature variations etc. will be tracked and compensated for in the power control loop.

The principles of the invention can be applied in TDMA (Time Division Multiple Access) systems with non-constant envelope modulation. An example of such a system is the above-mentioned EDGE system.

### BRIEF DESCRIPTION OF THE DRAWINGS

FIG. 1 is a block diagram illustrating one embodiment of the present invention;

FIG. 2 is a block diagram illustrating part of the embodiment of FIG. 1; and

FIG. 3 is a block diagram illustrating a second embodiment of the present invention.

### DETAILED DESCRIPTION OF THE PREFERRED EMBODIMENT

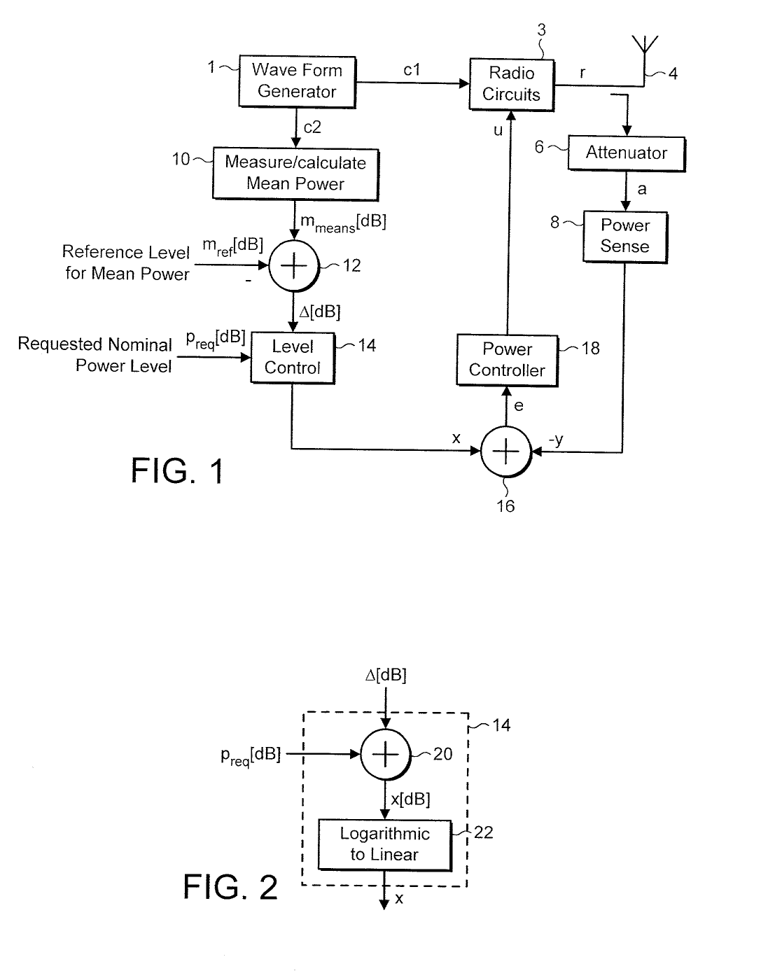

FIG. 1 illustrates a first embodiment of the present invention which comprises a waveform generator 1 which produces a first output signal cl. The output signal cl is supplied to a radio frequency circuit 3 which converts the signal cl into a radio frequency signal r for transmission from an antenna 4. The operation of the radio frequency circuit 3 is well known, and so a more detailed explanation will be omitted for the sake of clarity.

An attenuator 6 detects the radio frequency signal r to provide an attenuated signal a. The attenuated signal a is supplied to a power sense circuit 8 which produces a signal y which is proportional to the power of the attenuated signal a. The power sense circuit 8 may be, for example, an envelope detector.

A second output signal c2 from the waveform generator 1 is also supplied to a measurement unit 10 which operates to calculate the mean power level of the generated signal c2. The second signal c2 may be identical to the first signal cl, or one of the signals cl and c2 may be a time delayed version of the other. The mean power of the signal c2 is calculated or measured to form a mean power signal mₘₑₐₙ (in dB). The signal mₘₑₐₙ represents the mean power of the actual symbol sequence being sent in the current burst. The difference between mₘₑₐₙ and a reference signal m_{ref} (in dB) results in a difference signal Δ (in dB) being output from a signal combiner 12. The value of the reference signal m_{ref} could for example be chosen to represent the mean power of a very long symbol sequence in which all symbols have the same probability. The value Δ is a number which represents how much the power of the signal r can be expected to differ from a required level P_{req}, when the actual symbol sequence (burst) is sent. A signal P_{req} relating to the requested power level and value Δ are supplied to a level control block 14 to form a reference value, x.

As mentioned above, a portion of the RF (Radio Frequency) signal, r, is taken from the radio frequency circuitry. The signal r is attenuated in the attenuator 6 to form the signal a. The signal y of the power sense unit 18 is proportional to the power of the signal a.

The signal y is compared with the reference signal x by subtracting y from x using a combiner 16. The signal x is calculated (or measured) prior to the burst of information which is to be transmitted from the radio circuitry. The signal x is then present during the whole burst. The difference between the signals x and y forms an error signal e. The error signal e is calculated once per data burst. The error signal e is supplied to a power controller 18, which forms a control signal u. The signal u determines the gain to be used during the next data burst of an amplifier included in radio circuitry 3. Such a system provides automatic compensation of statistical variations in the amplitude of the information signal that is to be transmitted, and so these variations become “invisible” for the power control loop.

FIG. 2 illustrates the level control unit 14 of FIG. 1 in more detail. The level control unit 14 includes an adder 20 which produces a signal in decibels (dB) which corresponds to the required power level P_{req} (in dB) added to the difference value A (in dB). A logarithmic to linear converter 22 is provided to convert the decibel (dB) signal output from the adder 20 to a linear signal.

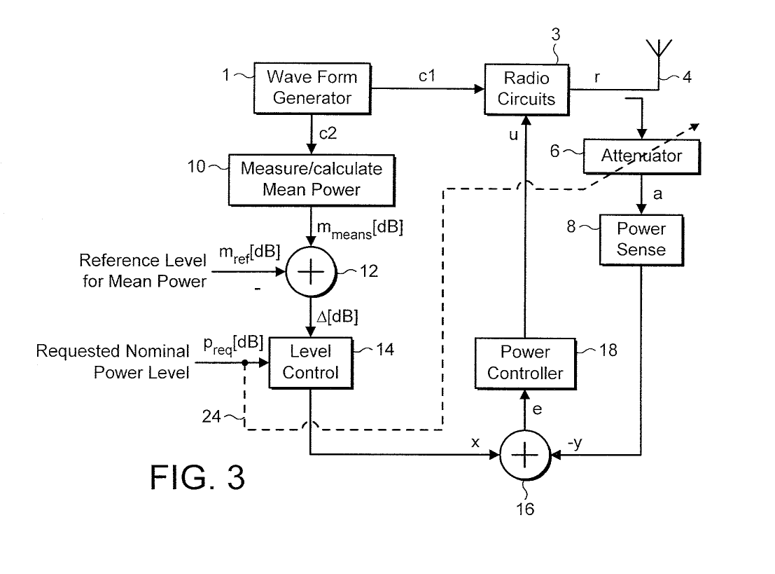

FIG. 3 illustrates a second embodiment of the invention in which the attenuation of the attenuator 6 is dependent of the requested nominal power level, P_{req}. Preferably the attenuation is proportional to the P_{req} signal. In this way, the attenuated power level signal a supplied to the power sense block 8 does not change much from one burst to another. This reduces the dynamic range requirement of the power sense block 8.

Merits of the invention are listed below:

Automatic compensation of statistical variations in the amplitude of the information signal that is to be transmitted, so that these variations become “invisible” for the power control loop.

In one of the embodiments (see FIG. 3) of the invention, the dynamic range requirement on the output power detector is decreased.

1. A method for controlling power output of a radio frequency transmitter, wherein information relating to statistical variations in the amplitude of the information signal that is to be transmitted is used to control a gain value of the radio frequency transmitter.

2. A method for controlling power output of a radio frequency transmitter, the method comprising:
detecting output power from the radio frequency transmitter for a first data burst thereby to produce a detected power control signal;
calculating or measuring an expected mean power level for an output signal for the first data burst;
calculating a difference between the expected mean power level and a reference mean power level, and producing a calculated power control signal from the said difference and a nominal power level;
comparing the calculated power control signal with the detected power control signal to produce a gain control signal; and
supplying the gain power control signal to the radio frequency transmitter, thereby to adjust the gain thereof for at least one data burst subsequent to the first data burst.

3. A method as claimed in claim 2, wherein the detected power control signal is produced by the steps of:
measuring the output signal of the radio frequency transmitter, thereby to produce a measured power level signal;
attenuating the measured power level signal; and
producing a detected power control signal which is proportional to the attenuated measured power level.

4. A method as claimed in claim 3, wherein the measured power level signal is attenuated by an amount proportional to the nominal power level.

5. Apparatus for controlling an output power of a radio frequency transmitter, comprising:
a detector operable to detect an output signal of a radio frequency transmitter and to produce a detected power signal indicative of the power of the output signal, the output signal relating to a first output data burst from the transmitter;
a device for calculating or measuring an expected mean power level relating to the first output data burst from the transmitter;
a power level calculation unit operable to obtain a difference between the expected mean power level and a reference power level, and to produce a calculated power control signal from the said difference and a nominal power level; and
a gain control unit for comparing the power control signal with the detected power level signal to produce a gain control signal for supply to the transmitter for at least one data burst subsequent to the first data burst.

6. Apparatus as claimed in claim 5, further comprising:
an attenuator connected to receive the output signal from the radio frequency transmitter and operable to output an attenuated signal to the detector.

7. Apparatus as claimed in claim 6, wherein the attenuator is operable to attenuate the output signal by an amount which is proportional to the nominal power level.

8. A radio frequency transmitter comprising:
a waveform generator operable to produce a waveform signal from input data;
radio frequency circuitry connected to receive the waveform signal and operable to output a radio frequency signal, the circuitry including an amplifier having variable gain;
a detector operable to detect an output signal of a radio frequency transmitter and to produce a detected power signal indicative of the power of the output signal, the output signal relating to a first output data burst from the transmitter;
a device for calculating or measuring an expected mean power level relating to the first output data burst from the transmitter;
a power level calculation unit operable to obtain a difference between the expected mean power level and a reference power level, and to produce a calculated power control signal from the said difference and a nominal power level; and
a gain control unit for comparing the power control signal with the detected power level signal to produce a gain control signal for supply to the transmitter for at least one data burst subsequent to the first data burst.

9. A transmitter as claimed in claim 8, further comprising:
an attenuator connected to receive the output signal from the radio frequency transmitter and operable to output an attenuated signal to the detector.

10. A transmitter as claimed in claim 9, wherein the attenuator is operable to attenuate the output signal by an amount which is proportional to the nominal power level.
